(19) United States
(12) Patent Application Publication
(10) Pub. No.: US 2025/0260931 A1
(43) Pub. Date: Aug. 14, 2025

(54) METHOD FOR MANUFACTURING LOUDSPEAKER DIAPHRAGM, LOUDSPEAKER, AND ELECTRONIC DEVICE

(71) Applicant: Huawei Technologies Co., Ltd., Shenzhen (CN)

(72) Inventors: Chunjiao Pan, Beijng (CN); Zhenxing Xu, Dongguan (CN); Yang Liu, Shanghai (CN); Renxuan Qin, Shanghai (CN); Zhipeng Chen, Dongguan (CN); Chao Xu, Shanghai (CN); Haibo Shan, Dongguan (CN); Jing Chang, Shanghai (CN)

(21) Appl. No.: 19/194,836

(22) Filed: Apr. 30, 2025

Related U.S. Application Data
(63) Continuation of application No. PCT/CN2023/126909, filed on Oct. 26, 2023.

(30) Foreign Application Priority Data
Nov. 4, 2022 (CN) 202211378326.9

(51) Int. Cl. H04R 7/10; H04R 9/06; H04R 31/00

(52) U.S. Cl. CPC H04R 7/10; H04R 9/06; H04R 31/003; H04R 2307/023; H04R 2307/025; H04R 2307/027; H04R 2499/15

(57) ABSTRACT

This application provides a method for manufacturing a loudspeaker diaphragm, a loudspeaker, and an electronic device. The method includes: adding nanosilver to a polythiophene solution to form a nanosilver-polythiophene slurry, where the nanosilver is evenly dispersed in the polythiophene solution; coating the nanosilver-polythiophene slurry on a diaphragm substrate, and performing drying processing to form a conductive layer on the diaphragm substrate; and manufacturing the diaphragm substrate having the conductive layer into the loudspeaker diaphragm. The diaphragm substrate includes a surround portion and a central portion, the surround portion surrounds a periphery of the central portion, the conductive layer is located on the surround portion, and the conductive layer extends from the surround portion toward the central portion.

### CROSS-REFERENCE TO RELATED APPLICATIONS

This application is a continuation of International Application No. PCT/CN2023/126909, filed on Oct. 26, 2023, which claims priority to Chinese Patent Application No. 202211378326.9, filed on Nov. 4, 2022. The disclosures of the aforementioned applications are hereby incorporated by reference in their entireties.

### TECHNICAL FIELD

This application relates to the field of terminal electronic devices, and specifically, to a method for manufacturing a loudspeaker diaphragm, a loudspeaker, and an electronic device.

### BACKGROUND

A loudspeaker is an electronic device that outputs an audible sound. A flexible printed circuit board (FPC) is disposed below a diaphragm of a conventional loudspeaker, to supply power to a voice coil through the FPC. The FPC occupies specific vibration space, which affects vibration and sound production of the diaphragm of the loudspeaker and increases an overall thickness of the loudspeaker.

Alternatively, power may be supplied to a voice coil through a conductive layer on the diaphragm. However, vibration and sound production of the diaphragm may be affected due to arrangement of the conductive layer, thereby reducing sound quality of the loudspeaker.

Therefore, how to improve the sound quality of the loudspeaker is an urgent problem to be resolved currently.

### SUMMARY

Embodiments of this application provide a method for manufacturing a loudspeaker diaphragm, a loudspeaker, and an electronic device. Nanosilver and polythiophene are used to manufacture a conductive layer on the diaphragm of the loudspeaker. The loudspeaker diaphragm has good smoothness and conductivity, thereby helping improve sound quality of the loudspeaker.

According to a first aspect, a method for manufacturing a loudspeaker diaphragm is provided. The method includes: adding nanosilver to a polythiophene solution to form a nanosilver-polythiophene slurry, where the nanosilver is evenly dispersed in the polythiophene solution; coating the nanosilver-polythiophene slurry on a diaphragm substrate, and performing drying processing to form a conductive layer on the diaphragm substrate; and manufacturing the diaphragm substrate having the conductive layer into the loudspeaker diaphragm. The diaphragm substrate includes a surround portion and a central portion, the surround portion surrounds a periphery of the central portion, the conductive layer is located on the surround portion, and the conductive layer extends from the surround portion toward the central portion.

In an embodiment of this application, the nanosilver and the polythiophene may be used to manufacture the conductive layer on the diaphragm of the loudspeaker. The nanosilver has good conductivity, and is evenly dispersed in the conductive layer, and a resistance fluctuation range is small, which helps improve conductivity of the conductive layer. The polythiophene can alleviate problems such as diaphragm substrate hardening and stiffness mutation that may be caused by the conductive layer, to ensure smoothness of the conductive layer on the diaphragm, and reduce impact of the conductive layer on vibration and sound production of the loudspeaker diaphragm, thereby helping improve sound quality of the loudspeaker.

Moreover, power may be supplied to a voice coil of the loudspeaker through the conductive layer on the loudspeaker diaphragm, so that an FPC does not need to be disposed, thereby avoiding impact of the FPC on vibration and sound production of the loudspeaker diaphragm. In addition, vibration space of the conductive diaphragm is increased, helping improve sound quality of the loudspeaker and reduce a size of the loudspeaker.

With reference to the first aspect, in a possible implementation, content of the nanosilver in the nanosilver-polythiophene slurry is greater than or equal to 5% and less than or equal to 20%.

With reference to the first aspect, in a possible implementation, content of the polythiophene in the nanosilver-polythiophene slurry is greater than or equal to 10% and less than or equal to 20%.

In this embodiment of this application, the content of the nanosilver and the polythiophene is adjusted, so that both conductivity and smoothness of the loudspeaker diaphragm can be achieved, helping improve sound quality of the loudspeaker.

With reference to the first aspect, in a possible implementation, the nanosilver in the nanosilver-polythiophene slurry is a silver nanowire.

A diameter of the silver nanowire is greater than or equal to 15 nm and less than or equal to 25 nm; and/or
a length of the silver nanowire is greater than or equal to 25 μm and less than or equal to 30 μm.

In this embodiment of this application, the nanosilver may be a silver nanowire, and the diameter and/or the length of the silver nanowire are/is designed to be within a specific range, so that phenomena such as uneven distribution and agglomeration of the silver nanowire can be reduced, thereby helping improve conductivity of the conductive layer and improving sound quality of the loudspeaker.

With reference to the first aspect, in a possible implementation, the method further includes: adding graphene to the polythiophene solution. Content of the graphene in the nanosilver-polythiophene slurry is less than or equal to 5%.

It should be understood that the graphene may be added before the nanosilver is added to the polythiophene solution, or may be added after the nanosilver is added to the polythiophene solution. This is not limited in this application.

It should be understood that the nanosilver-polythiophene slurry is a slurry including nanosilver and polythiophene. A nanosilver-polythiophene slurry to which another substance (for example, graphene) is added may also be referred to as the nanosilver-polythiophene slurry.

In this embodiment of this application, because the graphene has good conductivity, adding the graphene to the conductive layer can alleviate a local overheating phenomenon of the nanosilver during conducting, which helps ensure resistance stability and improve sound quality of the loudspeaker.

With reference to the first aspect, in a possible implementation, before the coating the nanosilver-polythiophene slurry on a diaphragm substrate, the method further includes: evenly dispersing the nanosilver in the polythiophene solution by using a blending and/or ultrasonic dispersion process.

With reference to the first aspect, in a possible implementation, the coating the nanosilver-polythiophene slurry on a diaphragm substrate includes: coating the nanosilver-polythiophene slurry on the diaphragm substrate by using a spin coating or screen-printing process.

With reference to the first aspect, in a possible implementation, before the coating the nanosilver-polythiophene slurry on a diaphragm substrate, the method further includes: performing, by using a surfactant, surface activation treatment on a side that is of the diaphragm substrate and that is close to the conductive layer.

In this embodiment of this application, after surface activation treatment is performed on the side that is of the diaphragm substrate and that is close to the conductive layer, a bonding force between the conductive layer and the diaphragm substrate is stronger. Therefore, the loudspeaker diaphragm is less prone to delamination, helping improve sound quality of the loudspeaker diaphragm.

With reference to the first aspect, in a possible implementation, the performing drying processing includes:
performing drying processing a plurality of times on the diaphragm substrate coated with the nanosilver-polythiophene slurry, where time for each drying processing is less than a preset value.

In this embodiment of this application, short-term drying processing is performed a plurality of times to avoid heat accumulation and prevent wrinkling in the loudspeaker diaphragm. This effectively improves smoothness of the loudspeaker diaphragm, helping improve sound quality of the loudspeaker.

According to a second aspect, a loudspeaker is provided. The loudspeaker includes:
a conductive diaphragm, where the conductive diaphragm includes a substrate layer and a conductive layer, the substrate layer includes a surround portion and a central portion, and the surround portion surrounds a periphery of the central portion; and
the conductive layer is disposed on the surround portion, the conductive layer extends from the surround portion toward the central portion, a material of the conductive layer includes nanosilver and polythiophene, and the nanosilver and the polythiophene are mixed and distributed in the conductive layer; and
a voice coil, where the voice coil is fastened to the central portion, and the voice coil is electrically connected to the conductive layer.

In this embodiment of this application, the conductive layer includes the nanosilver and the polythiophene that are mixed and distributed. The nanosilver has good conductivity, which helps improve conductivity of the conductive layer. The polythiophene can alleviate problems such as diaphragm substrate hardening and stiffness mutation that may be caused by the conductive layer, to ensure smoothness of the conductive layer on the diaphragm, and reduce impact of the conductive layer on vibration and sound production of the loudspeaker diaphragm, thereby helping improve sound quality of the loudspeaker.

Moreover, power may be supplied to the voice coil of the loudspeaker through the conductive layer on the loudspeaker diaphragm, so that an FPC does not need to be disposed, thereby avoiding impact of the FPC on vibration and sound production of the loudspeaker diaphragm. In addition, vibration space of the conductive diaphragm is increased, helping improve sound quality of the loudspeaker and reduce a size of the loudspeaker.

With reference to the second aspect, in a possible implementation, a ratio of the nanosilver to the polythiophene is greater than or equal to 0.25 and is less than or equal to 2.

In this embodiment of this application, content of the nanosilver and the polythiophene is adjusted, and the ratio of the nanosilver to the polythiophene is controlled to be within a specific range, so that both conductivity and smoothness of the loudspeaker diaphragm can be achieved, helping improve sound quality of the loudspeaker.

With reference to the second aspect, in a possible implementation, the method further includes: The nanosilver is a silver nanowire, a diameter of the silver nanowire is greater than or equal to 15 nm and less than or equal to 25 nm, and/or a length of the silver nanowire is greater than or equal to 25 μm and less than or equal to 30 μm.

In this embodiment of this application, the nanosilver may be a silver nanowire, and the diameter and/or the length of the silver nanowire are/is designed to be within a specific range, so that phenomena such as uneven distribution and agglomeration of the silver nanowire can be reduced, thereby helping improve conductivity of the conductive layer and improving sound quality of the loudspeaker.

With reference to the second aspect, in a possible implementation, the nanosilver is evenly distributed in the conductive layer.

In this embodiment of this application, the nanosilver is evenly dispersed in the conductive layer, which helps improve conductivity of the conductive layer, allows resistance of the conductive layer to fluctuate within a small range, and helps improve sound quality of the loudspeaker.

With reference to the second aspect, in a possible implementation, the material of the conductive layer further includes graphene. The graphene, the nanosilver, and the polythiophene are mixed and distributed; or the conductive layer includes a graphene layer, and the graphene layer is disposed on a side that is of the conductive layer and that is away from the substrate layer.

In this embodiment of this application, because the graphene has good conductivity, adding the graphene to the conductive layer can alleviate a local overheating phenomenon of the nanosilver during conducting, which helps ensure resistance stability and improve sound quality of the loudspeaker.

With reference to the second aspect, in a possible implementation, the conductive diaphragm further includes an adhesive layer. The adhesive layer is located between the substrate layer and the conductive layer, or a side that is of the substrate layer and that is close to the conductive layer is surface-treated with a surfactant.

With reference to the second aspect, in a possible implementation, the conductive diaphragm further includes an antioxidation layer, and the antioxidation layer covers the conductive layer.

In this embodiment of this application, the antioxidation layer can effectively prevent oxidation of the nanosilver, thereby ensuring that resistance of the conductive layer fluctuates within a small range, helping improve conductivity of the conductive layer, and improving sound quality of the loudspeaker.

With reference to the second aspect, in a possible implementation, the conductive diaphragm further includes a first pad. The first pad is located in the central portion, and the voice coil is electrically connected to the conductive layer through the first pad.

With reference to the second aspect, in a possible implementation, the conductive diaphragm further includes a second pad. The second pad is located on a side that is of the surround portion and that is away from the central portion, and the conductive layer is electrically connected to a power supply device through the second pad.

According to a third aspect, an electronic device is provided. The electronic device includes the loudspeaker in any one of the possible implementations of the second aspect.

### BRIEF DESCRIPTION OF THE DRAWINGS

FIG. 1 is a diagram of a structure of an electronic device according to an embodiment of this application;

FIG. 2 is a diagram of a structure of a loudspeaker according to an embodiment of this application;

FIG. 3 is a diagram of a structure of a loudspeaker according to an embodiment of this application;

FIG. 4 is a diagram of a structure of a loudspeaker diaphragm according to an embodiment of this application;

FIG. 5 is a diagram of a structure of a loudspeaker according to an embodiment of this application; and

FIG. 6 is a schematic flowchart of a method for manufacturing a loudspeaker diaphragm according to an embodiment of this application.

### DETAILED DESCRIPTION OF ILLUSTRATIVE EMBODIMENTS

The following describes embodiments of this application in detail. Examples of embodiments of this application are shown in the accompanying drawings. In the accompanying drawings, same or similar reference numerals indicate same or similar elements or elements having same or similar functions. The following embodiments described with reference to the accompanying drawings are examples, and are merely intended to explain this application, but should not be construed as a limitation on this application.

In this application, the terms “first”, “second”, “third”, “fourth”, and the like (if existent) are intended to distinguish between similar objects but do not necessarily describe a specific order or sequence. It should be understood that the data termed in such a way are interchangeable in proper circumstances so that embodiments of this application described herein can be implemented in other orders than the order illustrated or described herein. The term “and/or” in embodiments of this application describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

Unless otherwise defined, technical terms or scientific data used in this application should have a general meaning understood by a person of ordinary skill in the technical field of this application. In descriptions of this application, it should be understood that orientations or location relationships indicated by terms such as “center”, “longitudinal”, “lateral”, “up”, “down”, “front”, “back”, “left”, “right”, “vertical”, “horizontal”, “top”, “bottom”, “inside”, and “outside” are orientations or location relationships that are shown based on the accompanying drawings, and are merely intended to facilitate the descriptions of this application and simplify the descriptions, but are not intended to indicate or imply that an indicated apparatus or element needs to have a specific orientation or needs to be constructed and operated in a specific orientation, and therefore cannot be understood as a limitation on this application.

To make technical problems resolve, technical solutions used, and technical effect achieved in this application clearer, the following further describes the technical solutions in embodiments of this application in detail with reference to the accompanying drawings. It is clear that the described embodiments are merely some rather than all of embodiments of this application.

The following describes an electronic device, and embodiments in which such electronic device is used. In some embodiments, the electronic device may be a portable electronic device that further includes another function like a personal digital assistant function and/or a music player function, for example, a mobile phone, a tablet computer, or a wearable electronic device (for example, a smartwatch) having a wireless communication function. An example embodiment of a portable electronic device includes but is not limited to a portable electronic device using iOS®, Android®, Microsoft®, or another operating system. The portable electronic device may alternatively be another portable electronic device, such as a laptop (Laptop). It should be further understood that, in some other embodiments, the foregoing electronic device may not be the portable electronic device but a desktop computer.

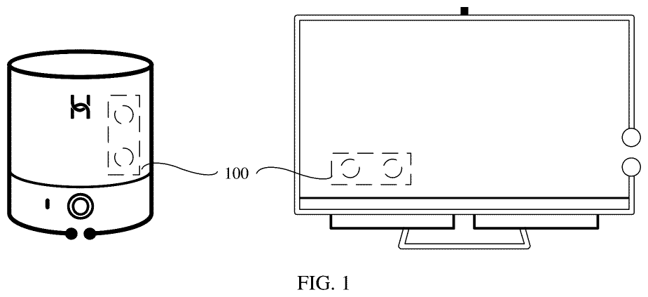

FIG. 1 is a diagram of an electronic device according to an embodiment of this application. The electronic device includes a loudspeaker 100. The electronic device may further include a plurality of components such as a camera, a display, and a power supply. The electronic device may be an electronic device with a display, such as a mobile phone, a desktop computer, a notebook computer, a vehicle-mounted device, or a smart screen, or an electronic device without a display, such as a smart speaker or a Bluetooth headset. A specific type of the electronic device is not limited in this embodiment of this application.

In some embodiments, a first electronic device includes the loudspeaker 100. The first electronic device may be connected to a second electronic device through Bluetooth, Wi-Fi, or a connection cable, and be used as a sound production unit of the second electronic device.

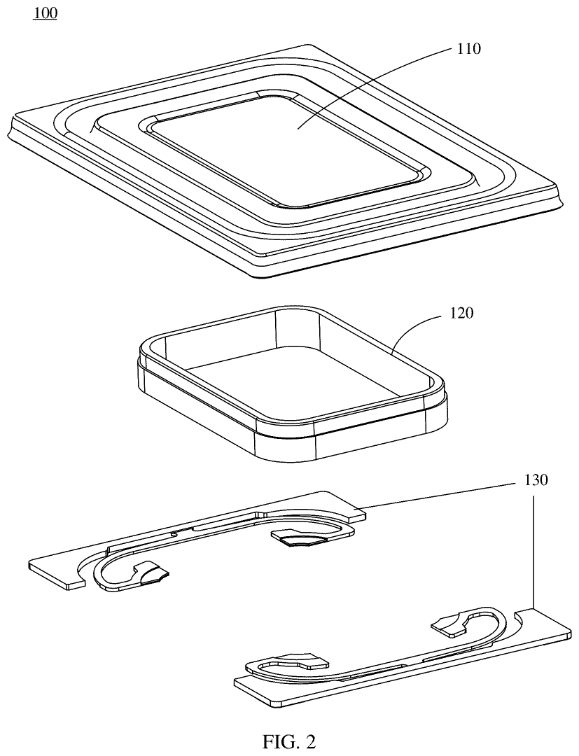

FIG. 2 is a diagram of a structure of a loudspeaker 100 according to an embodiment of this application. The loudspeaker 100 may include structures such as a basin frame, a vibration assembly, and a magnetic circuit system (not shown in FIG. 2). The basin frame may be configured to provide a support platform for structures such as a vibration structure and the magnetic circuit system. The magnetic circuit system may include a magnet, a magnetic conductive sheet, a magnetic bowl, and the like. The magnetic circuit system may generate a constant magnetic field with an unchanged magnitude and direction.

Refer to FIG. 2. The vibration assembly may include a diaphragm 110 and a voice coil 120. An edge of the diaphragm 110 may be fastened to the basin frame. The voice coil 120 may include a framework and a coil wound around the framework. The voice coil 120 is located in the magnetic field formed by the magnetic circuit system, and is fastened to the diaphragm 110. After the voice coil 120 is energized, the voice coil 120 may cut through magnetic field lines in a magnetic gap, to generate up and down vibrations. Vibration of the voice coil 120 drives the diaphragm 110 to vibrate, and the diaphragm 110 drives air to vibrate, so that the loudspeaker 100 produces a sound.

In a conventional structure of a loudspeaker, power is usually supplied to a voice coil 120 through an FPC 130. The FPC 130 may be disposed above the voice coil 120, and is electrically connected to the voice coil 120, that is, an upper FPC structure. Alternatively, the FPC 130 may be disposed below the voice coil 120, and is electrically connected to the voice coil 120, that is, a lower FPC structure. Regardless of the upper FPC structure or the lower FPC structure, the FPC occupies specific vibration space, affects vibration and sound production of a loudspeaker diaphragm, and increases an overall size of the loudspeaker.

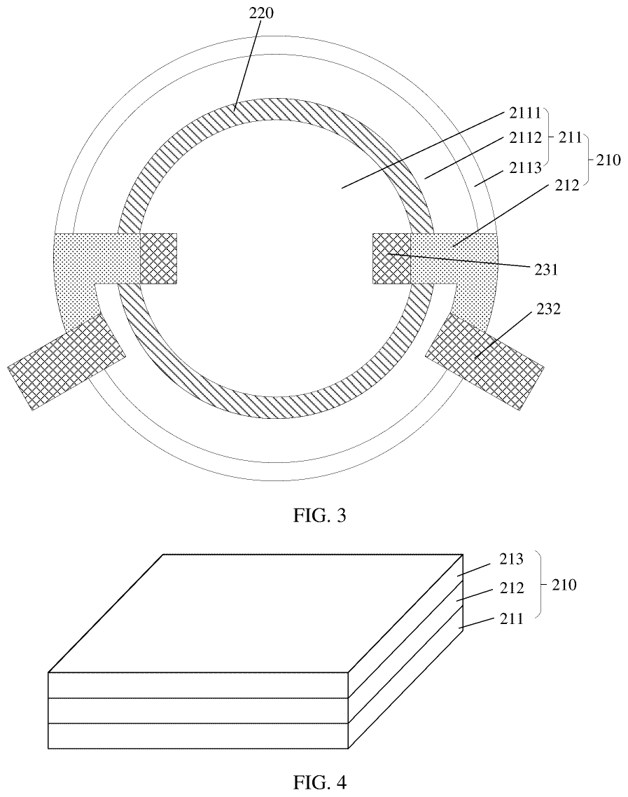

The following describes a structure of a loudspeaker in this application with reference to FIG. 3 and FIG. 4. FIG. 3 is a diagram of a structure of a loudspeaker according to an embodiment of this application. FIG. 4 is a diagram of a structure of a loudspeaker diaphragm according to an embodiment of this application.

Refer to FIG. 3 and FIG. 4. A loudspeaker 200 may include a conductive diaphragm 210 and a voice coil 220. The conductive diaphragm 210 may be a multi-layer structure. For example, the conductive diaphragm 210 may include a substrate layer 211 and a conductive layer 212.

The substrate layer 211 is equivalent to a diaphragm in a conventional loudspeaker, and is mainly used as a sound production unit of the loudspeaker. A material of the substrate layer 211 may be a common loudspeaker diaphragm material such as polyetheretherketone (PEEK), thermoplastic polyurethanes (TPU), TPEE (thermoplastic polyester elastomer), LCP, polyethylene naphthalate two formic acid glycol ester (PEN), and silica gel.

A material of the conductive layer 212 may include nanosilver and polythiophene (polythiophene). The nanosilver and the polythiophene are mixed and distributed together to form the conductive layer 212. It should be understood that the nanosilver may be evenly dispersed or evenly distributed in the conductive layer or the polythiophene.

It should be noted that the nanosilver may be a silver nanowire or silver nanopowder. The silver nanowire is a one-dimensional silver metal material with a length of micrometers and a diameter of nanometers. The polythiophene is a conductive polymer, which can alleviate problems such as diaphragm substrate hardening and stiffness mutation due to arrangement of the conductive layer on the substrate layer, and ensure smoothness of the conductive diaphragm.

In this embodiment of this application, the conductive layer 212 may cover a surface of the substrate layer 211 through spin coating or screen printing.

In some embodiments, the nanosilver may be a silver nanowire, a diameter of the silver nanowire should be greater than or equal to 15 nm and less than or equal to 25 nm, and/or a length of the silver nanowire should be greater than or equal to 25 μm and less than or equal to 30 μm.

It should be noted that, an improper diameter or wire length of the silver nanowire may lead to phenomena such as uneven dispersion and agglomeration. Adding the silver nanowire with the foregoing diameter and/or wire length to the polythiophene solution may make the silver nanowire evenly dispersed, and have relatively good conductivity, which helps improve sound quality of the loudspeaker.

In some embodiments, both conductivity and smoothness can be achieved by designing the nanosilver and the polythiophene in a specific ratio range, for example, a ratio of the nanosilver to the polythiophene is greater than or equal to 0.25 and less than or equal to 2.

Optionally, the material of the conductive layer 212 may further include graphene. The graphene, the nanosilver, and the polythiophene are mixed and distributed in the conductive layer.

Optionally, the material of the conductive layer 212 may further include a dispersant, for example, polyvinyl alcohol or polytetrafluoroethylene.

Optionally, the conductive diaphragm 210 may further include an antioxidation layer 213. The antioxidation layer 213 may cover a surface of the conductive layer 212 through evaporation, spin coating, screen printing, or the like. The antioxidation layer 213 may be made of a material that is not easily oxidized, such as titanium oxide and aluminum oxide, or may be made of some insulating materials, such as a polyimide film and a composite protective film. The antioxidation layer can prevent oxidation of the silver nanowire, thereby ensuring a resistance fluctuation range of the conductive layer is small.

Optionally, the conductive layer 212 may further include a graphene layer. The graphene layer is located on a side that is of the conductive layer 212 and that is away from the substrate layer 211. For example, the graphene layer may be located between a layer in which the nanosilver and the polythiophene are located and the antioxidation layer. It should be understood that the graphene may be mixed with the nanosilver and the polythiophene, or may be used as a separate layer.

Still refer to FIG. 3. The substrate layer 211 may include a central portion 2111, a surround portion 2112, and an edge portion 2113. The central portion 2111 is a central area of the substrate layer 211. The edge portion 2113 is located on a peripheral edge of the substrate layer 211, and the edge portion 2113 may be fastened to a basin frame or a housing of the loudspeaker. The surround portion 2112 is located between the central portion 2111 and the edge portion 2113. The surround portion 2112 is a structure protruding from the central portion 2111 and the edge portion 2113, and surrounds a periphery of the central portion 2111. In FIG. 3, a pattern filled with oblique lines is the voice coil 220, and the voice coil 220 may be fastened to the central portion 2111.

In FIG. 3, a pattern filled with dot matrices is the conductive layer 212. The conductive layer 212 is configured to supply power to the voice coil 220. For example, one end of the conductive layer 212 may be electrically connected to the voice coil 220, and the other end of the conductive layer 212 may be electrically connected to a power supply device (for example, an audio driver and a power supply), to supply power to the voice coil 220. The conductive layer 212 is disposed on a surface that is of the substrate layer 211 and that faces the voice coil 220, that is, a surface that corresponds to a protruding surface of the surround portion. The conductive layer 212 may cross the surround portion 2112, and extend toward the central portion 2111 in a direction perpendicular to the surround portion 2112, so that the conductive layer 212 is close to the voice coil 220. In this case, the voice coil 220 may be conducted to the outside through the conductive layer 212.

It should be understood that the conductive layer 212 may cross the surround portion 2112, and a part of the conductive layer 212 may cover the central portion 2111.

In some embodiments, the conductive layer 212 may cross the surround portion 2112, one end of the conductive layer 212 is located in the central portion 2111, and the other end of the conductive layer 212 is located in the edge portion 2113.

The conductive layer 212 may be electrically connected to the voice coil 220 or the power supply device through soldering. Still refer to FIG. 3, an inner pad 231 may be disposed at one end that is of the conductive layer 212 and that is close to the voice coil 220, and an outer pad 232 may be disposed at one end that is of the conductive layer 212 and that is away from the voice coil 220. The inner pad 231 is located on an inner side of the voice coil 220, that is, the inner pad 231 is located in an area surrounded by a vertical projection of the voice coil 220 on the conductive diaphragm 210. The outer pad 232 may be located at the edge portion 2113, or a part of the outer pad 232 may be located at the edge portion 2113, and the other part of the outer pad 232 may be located at the surround portion 2112.

A lead of the conductive layer 212 and a lead of the voice coil 220 may be welded on the inner pad 231, and a lead of the conductive layer 212 and a lead of the power supply device may be welded on the outer pad 232.

It should be noted that, in this application, a pattern filled with grids may represent a pad. The pad may also be referred to as a solder mask. The pad may be disposed on the conductive diaphragm 210 through electroplating, spot soldering, or coating. A material of the pad may be a metal material, for example, copper or silver. Alternatively, the pad may be made of a same material as the conductive layer.

It should be understood that both the inner pad 231 and the outer pad 232 are located on a surface that is of the conductive diaphragm 210 and that faces the voice coil 220. Both the inner pad 231 and the outer pad 232 are electrically connected to the conductive layer 212. For example, at least a part of the inner pad 231 and the outer pad 232 covers the surface of the conductive layer 212, or at least a part of the inner pad 231 and the outer pad 232 is bonded to the conductive layer 212, to ensure that the inner pad 231 and the outer pad 232 are electrically connected to the conductive layer 212.

In this embodiment of this application, an orthographic projection of the inner pad 231 on the conductive diaphragm 210 does not overlap the surround portion 2112, that is, the inner pad 232 is not in contact with the surround portion 2112. In this way, impact caused by a soldering region on vibration and sound production of the diaphragm can be reduced, helping improve sound quality of the loudspeaker.

It should be noted that the voice coil 220 may include a plurality of leads, for example, may include a first lead and a second lead. When the voice coil 220 is powered, two conductive layers may be disposed, where one conductive layer is electrically connected to the first lead, and the other conductive layer is electrically connected to the second lead.

It should be understood that the conductive layer may be electrically connected to the lead of the voice coil directly through soldering, and no pad is disposed. Therefore, a quantity of pads may be designed according to a requirement, including but not limited to inner and outer pads, outside double pads, inside double pads, or the like.

It should be noted that, when there are two inner pads, spacing between the two inner pads is not less than 0.2 mm.

It should be noted that shapes and locations of the inner pad 231 and the outer pad 232 may be set according to an actual requirement. The inner pad 231 and the outer pad 232 may be in the shape of a rectangle, a circle, or the like. This is not limited in this application.

A shape of the conductive layer 212 may be set according to an actual requirement. For example, the conductive layer 212 is in the shape of a long strip; or the conductive layer 212 is in the shape of an arc; or a part of the conductive layer 212 may be in the shape of an arc, and the other part of the conductive layer 212 is in the shape of a rectangle.

In this embodiment of this application, a thickness of the conductive layer 212 is about 5 μm to 20 μm, a width of the conductive layer 212 is about 0.5 mm to 2 mm, and a proportion of an area of the conductive layer 212 to an area of the substrate layer 211 is about 10% to 40%. If the conductive layer is excessively thin or small, conductive effect may be poor. If the conductive layer is excessively thick or large, vibration and sound production of the conductive diaphragm may be affected. When the conductive layer is within the foregoing thickness and area range, sound quality effect of the loudspeaker is relatively good.

Based on the foregoing solution, the voice coil may be conducted to the outside through the conductive layer structure of the diaphragm, so that an FPC does not need to be disposed. This avoids impact of the FPC on the vibration and sound production of the diaphragm, and helps improve sound quality of the loudspeaker. Moreover, vibration space is reduced, helping reduce a size of the loudspeaker.

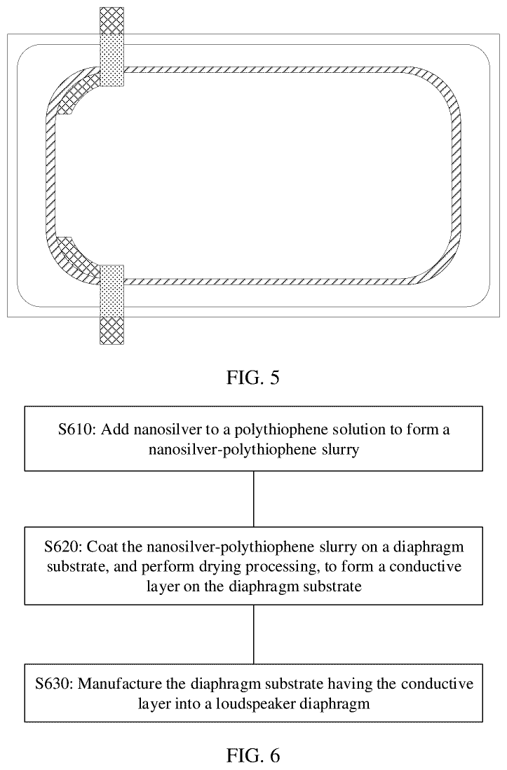

FIG. 5 is a diagram of a structure of another loudspeaker according to an embodiment of this application. For the structure of the loudspeaker shown in FIG. 5, refer to related descriptions of the loudspeaker 200. Only a difference is described herein.

Refer to FIG. 5. A substrate layer of a conductive diaphragm of the loudspeaker may be in the shape of a square or a racetrack. A conductive layer of the conductive diaphragm may be in the shape of a long strip, and crosses a surround.

It should be understood that the substrate layer of the conductive diaphragm of the loudspeaker may be in the shape of a circular, a square, or a racetrack. A shape of the diaphragm is not limited in this application.

FIG. 6 is a schematic flowchart of a method for manufacturing a conductive diaphragm according to an embodiment of this application. The method includes the following steps.

S610: Add nanosilver to a polythiophene solution to form a nanosilver-polythiophene slurry.

Specifically, the polythiophene solution is first manufactured, and polythiophene is dissolved in a solvent formed by ionized water, anhydrous ethanol, and isopropanol. Then the nanosilver is added to the polythiophene solution, and the nanosilver is evenly dispersed in the polythiophene solution. For example, the nanosilver may be evenly dispersed in the polythiophene solution through blending and/or ultrasonic dispersion.

In this embodiment of this application, the nanosilver may be a silver nanowire or silver nanopowder. This is not limited in this embodiment of this application.

In this embodiment of this application, in the nanosilver-polythiophene slurry, content of nanosilver may be greater than or equal to 5% and less than or equal to 20%, and content of polythiophene may be greater than or equal to 2% and less than or equal to 20%.

In some embodiments, the nanosilver may be a silver nanowire. A diameter of the silver nanowire is greater than or equal to 15 nm and less than or equal to 25 nm, and/or a length of the silver nanowire is greater than or equal to 25 μm and less than or equal to 30 μm.

It should be noted that, improper content, diameter or wire length of the silver nanowire may lead to phenomena such as uneven dispersion and agglomeration. Adding the silver nanowire with the foregoing content, diameter and/or wire length to the polythiophene solution may make the silver nanowire evenly dispersed, and have relatively good conductivity, which helps improve sound quality of a loudspeaker.

It should be noted that the silver nanowire is a one-dimensional silver metal material with a length of micrometers and a diameter of nanometers, and has good conductivity. The polythiophene is a conductive polymer, which can alleviate problems such as diaphragm substrate hardening and stiffness mutation due to coating of the nanosilver-polythiophene slurry on a diaphragm substrate, and ensure smoothness of the conductive diaphragm.

It should be noted that, in comparison with a solution in which silver nanopowder is used, the silver nanowire is more easily to be evenly dispersed in the polythiophene solution, and is not easily agglomerated together, which helps improve conductivity.

In some embodiments, both conductivity and smoothness can be achieved by designing the nanosilver and the polythiophene in a specific ratio range, for example, a ratio of the nanosilver to the polythiophene is greater than or equal to 0.25 and less than or equal to 2.

In some embodiments, graphene or a dispersant may be further added to the polythiophene solution, to avoid local overheating of the diaphragm caused by the nanosilver. The dispersant may be polyvinyl alcohol, polytetrafluoroethylene, or the like. This is not limited in this embodiment of this application.

Optionally, content of the graphene in the nanosilver-polythiophene slurry is less than or equal to 5%, and content of the dispersant in the nanosilver-polythiophene slurry is about 10%.

It should be understood that the graphene and the dispersant may be added before the nanosilver is added to a polythiophene container, or may be added after the nanosilver is added to the polythiophene solution.

It should be understood that the nanosilver-polythiophene slurry is a slurry including nanosilver and polythiophene, and may also include another substance, for example, graphene or a dispersant.

It should be noted that in the nanosilver-polythiophene slurry, the nanosilver, polythiophene, graphene, dispersant, and the like should be in a mixed distribution state.

S620: Coat the nanosilver-polythiophene slurry on the diaphragm substrate, and perform drying processing, to form a conductive layer on the diaphragm substrate.

For example, the nanosilver-polythiophene slurry may be coated on the diaphragm substrate through spin coating, screen printing or the like. A manner of coating the nanosilver-polythiophene slurry on the diaphragm substrate is not limited in this embodiment of this application. For example, a shield layer may be first disposed on the diaphragm substrate, and then the shield layer is removed after the nanosilver-polythiophene slurry is coated on the diaphragm substrate.

It should be understood that the diaphragm substrate is partially coated with the nanosilver-polythiophene slurry to form a local conductive layer. That is, at least a part of the diaphragm substrate is covered with the conductive layer formed by nanosilver-polythiophene slurry.

In some embodiments, before the nanosilver-polythiophene slurry is coated on the diaphragm substrate, surface activation treatment may be performed on the diaphragm substrate, for example, surface activation treatment may be performed by using a surfactant. After the surface activation treatment is performed, surface adhesion of the diaphragm substrate is improved, and the diaphragm substrate can be effectively composited with the conductive layer formed by the nanosilver-polythiophene slurry, preventing delamination. The surfactant may be sodium linear alkylbenzene sulfonate, sodium α-olefin sulfonate, or the like.

In some embodiments, an adhesive layer may be further coated on the diaphragm substrate, and then the nanosilver-polythiophene slurry is coated on the adhesive layer. In this way, a bonding force between the diaphragm substrate and the conductive layer can be increased, preventing delamination.

In some embodiments, an antioxidation layer may be further covered on the conductive layer through spin coating, screen printing, evaporation, or the like. The antioxidation layer may be made of a material that is not easily oxidized, such as titanium oxide and aluminum oxide, or may be made of some insulating materials, such as a polyimide film and a composite protective film. The antioxidation layer can prevent oxidation of the silver nanowire, thereby ensuring a resistance fluctuation range of the conductive layer is small.

In some embodiments, a graphene layer may be further disposed on a side that is of the conductive layer and that is away from the diaphragm substrate, to prevent local overheating of the nanosilver in the conductive layer, and to avoid affecting conductivity of the conductive layer, thereby helping improve sound quality of the loudspeaker.

In some embodiments, the drying processing may be performed a plurality of times on the diaphragm substrate coated with the nanosilver-polythiophene slurry, and time for each drying processing is less than a preset value. For example, a drying temperature may be set to 80° C., and the drying processing is performed five times, and each drying processing lasts 50 seconds to 100 seconds.

During actual verification process, the time for each drying processing should not be excessively long. Long-term drying processing at a high temperature may cause wrinkling in a film material. Short-term drying processing is performed a plurality of times to avoid heat accumulation during drying processing, and smoothness of the conductive diaphragm after drying can be effectively improved.

S630: Manufacture the diaphragm substrate having the conductive layer as a loudspeaker diaphragm.

In a possible implementation, the diaphragm substrate is a flat film. A shape of the diaphragm substrate having the conductive layer is adjusted by using a subsequent process, so that the diaphragm substrate having the conductive layer can be used as the diaphragm of the loudspeaker. For example, a surround portion surrounding a periphery of a central portion forms a periphery of the diaphragm substrate.

It should be understood that a location and an area of the nanosilver-polythiophene slurry coated on the diaphragm substrate are designed, that is, a location and an area of the conductive layer may be designed. When the shape of the diaphragm substrate is adjusted, the conductive layer can cross the surround portion, be located above the surround portion, and extend toward the central portion, so that a voice coil can be powered through the conductive layer.

It should be understood that the conductive layer should be located on a side that is of the diaphragm and that faces the voice coil.

In another possible implementation, the diaphragm substrate has a shape of the diaphragm of the loudspeaker, that is, the diaphragm substrate has the surround portion and the central portion. The nanosilver-polythiophene slurry coated on the diaphragm substrate may cross the surround portion and extend toward the central portion, so that the voice coil can be powered through the conductive layer. That is, after the conductive layer is formed on the diaphragm substrate, the shape of the diaphragm substrate does not need to be adjusted.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Embodiments of this application and the features in embodiments may be mutually combined when there is no conflict. Therefore, the protection scope of this application shall be subject to the protection scope of the claims.

What is claimed is:

1. A loudspeaker, comprising:
a conductive diaphragm, comprising a substrate layer and a conductive layer, wherein the substrate layer comprises a surround portion and a central portion, the surround portion surrounds a periphery of the central portion, the conductive layer is disposed on the surround portion, the conductive layer extends from the surround portion toward the central portion, a material of the conductive layer comprises nanosilver and polythiophene, and the nanosilver and the polythiophene are mixed and distributed in the conductive layer; and
a voice coil, wherein the voice coil is fastened to the central portion, and the voice coil is electrically connected to the conductive layer.

2. The loudspeaker according to claim 1, wherein a ratio of the nanosilver to the polythiophene is greater than or equal to 0.25 and less than or equal to 2.

3. The loudspeaker according to claim 1, wherein the nanosilver is a silver nanowire, and wherein:
a diameter of the silver nanowire is greater than or equal to 15 nm and less than or equal to 25 nm; or
a length of the silver nanowire is greater than or equal to 25 μm and less than or equal to 30 μm.

4. The loudspeaker according to claim 1, wherein the nanosilver is evenly distributed in the conductive layer.

5. The loudspeaker according to claim 1, wherein:
the material of the conductive layer further comprises graphene, and the graphene, the nanosilver, and the polythiophene are mixed and distributed; or
the conductive layer comprises a graphene layer, and the graphene layer is disposed on a side that is of the conductive layer and that is away from the substrate layer.

6. The loudspeaker according to claim 1, wherein the conductive diaphragm further comprises an adhesive layer; and
wherein:
the adhesive layer is located between the substrate layer and the conductive layer, or
a side that is of the substrate layer that is closest to the conductive layer is surface-treated with a surfactant.

7. The loudspeaker according to claim 1, wherein the conductive diaphragm further comprises an antioxidation layer, and the antioxidation layer covers the conductive layer.

8. The loudspeaker according to claim 1, wherein the conductive diaphragm further comprises a first pad, the first pad is located in the central portion, and the voice coil is electrically connected to the conductive layer through the first pad.

9. The loudspeaker according to claim 1, wherein the conductive diaphragm further comprises a second pad, the second pad is located on a side of the surround portion that is other than a side that is closest to the central portion, and the conductive layer is electrically connected to a power supply device through the second pad.

10. An electronic device, comprising:
a loudspeaker, comprising a conductive diaphragm, wherein the conductive diaphragm comprises a substrate layer and a conductive layer, the substrate layer comprises a surround portion and a central portion, the surround portion surrounds a periphery of the central portion, the conductive layer is disposed on the surround portion, the conductive layer extends from the surround portion toward the central portion, a material of the conductive layer comprises nanosilver and polythiophene, and the nanosilver and the polythiophene are mixed and distributed in the conductive layer; and
a voice coil, wherein the voice coil is fastened to the central portion, and the voice coil is electrically connected to the conductive layer.

11. The electronic device according to claim 10, wherein a ratio of the nanosilver to the polythiophene is greater than or equal to 0.25 and less than or equal to 2.

12. The loudspeaker according to claim 10, wherein the nanosilver is a silver nanowire; and
wherein:
a diameter of the silver nanowire is greater than or equal to 15 nm and less than or equal to 25 nm; or
a length of the silver nanowire is greater than or equal to 25 μm and less than or equal to 30 μm.

13. The loudspeaker according to claim 10, wherein the nanosilver is evenly distributed in the conductive layer.

14. The loudspeaker according to claim 10, wherein:
the material of the conductive layer further comprises graphene, and the graphene, the nanosilver, and the polythiophene are mixed and distributed; or
the conductive layer comprises a graphene layer, and the graphene layer is disposed on a side that is of the conductive layer and that is away from the substrate layer.

15. The loudspeaker according to claim 10, wherein the conductive diaphragm further comprises an adhesive layer; and
wherein the adhesive layer is located between the substrate layer and the conductive layer; or
a side that is of the substrate layer that is closest to the conductive layer is surface-treated with a surfactant.

16. The loudspeaker according to claim 10, wherein the conductive diaphragm further comprises an antioxidation layer, and the antioxidation layer covers the conductive layer.

17. The loudspeaker according to claim 10, wherein the conductive diaphragm further comprises a first pad, the first pad is located in the central portion, and the voice coil is electrically connected to the conductive layer through the first pad.

18. The loudspeaker according to claim 10, wherein the conductive diaphragm further comprises a second pad, the second pad is located on a side that is of the surround portion and that is other than a side that is closest to the central portion, and the conductive layer is electrically connected to a power supply device through the second pad.

19. The loudspeaker according to claim 11, wherein:
the material of the conductive layer further comprises graphene, and the graphene, the nanosilver, and the polythiophene are mixed and distributed; or
the conductive layer comprises a graphene layer, and the graphene layer is disposed on a side that is of the conductive layer and that is other that a side that is closest to the substrate layer.

20. The loudspeaker according to claim 12, wherein:
the material of the conductive layer further comprises graphene, and the graphene, the nanosilver, and the polythiophene are mixed and distributed; or
the conductive layer comprises a graphene layer, and the graphene layer is disposed on a side that is of the conductive layer and that is other than a side that is closest to the substrate layer.
